(19) United States
(12) Patent Application Publication
(10) Pub. No.: US 2009/0277659 A1
(43) Pub. Date: Nov. 12, 2009

(54) HAMMER DRILL

(76) Inventors: Andreas Roelfs, Pforzheim (DE); Rainer Kumpf, Ilsfeld (DE)

Correspondence Address: CARLSON, GASKEY & OLDS, P.C., 400 WEST MAPLE ROAD, SUITE 350, BIRMINGHAM, MI, 48009, US

(21) Appl. No.: 12/437,019

(22) Filed: May 7, 2009

(30) Foreign Application Priority Data
May 8, 2008 (DE) 102008022454.5-14

(51) Int. Cl. B25D 11/06; B25D 16/00; B23B 45/16

(52) U.S. Cl. 173/201; 173/217

(57) ABSTRACT

A hammer drill for manually guided operation includes an electric drive motor, a tool spindle and a pneumatic hammer function. The hammer drill includes a pressure piston, a striker, and a beat piece for striking axially against a tool that is held by the tool spindle. When the striker reaches a forward limit position, an end section thereof protrudes into a retaining ring that is aligned coaxially with the spindle axis. Manufacturing quality can be improved by bracing the retaining ring against an annular collar in the tool spindle on the one side and axially against a locking ring set in an annular groove conformed in the tool spindle via a retaining disc on the other side. The retaining ring, the retaining disc and the non-return disc are each mirror-symmetrical.

### REFERENCE TO RELATED APPLICATION

This application claims priority to German Patent Application No. 102008022454.5-14 filed May 8, 2008.

### BACKGROUND OF THE INVENTION

The present invention relates to a hammer drill for manually guided operation.

A hammer drill that is intended for manually guided operation normally includes an electric drive motor, a tool spindle that can be driven about a spindle axis, and a pneumatic hammer function. A hammer drill of such kind is known from German patent number DE 10 2006 054 288 filed of Nov. 17, 2006. In this hammer drill, the pneumatic hammer function has a pressure piston disposed in the tool spindle that is displaceable in reciprocating linear fashion, a striker located in the tool spindle that is actuated pneumatically by the pressure piston, and a beat piece located in the tool spindle that may be propelled by the striker to strike axially against a tool that is held by the tool spindle. The hammer function further includes a retaining ring arranged coaxially with the spindle axis, and into which the end section of the striker projects when the striker reaches a forward end position. In particular, the retaining ring can retain the striker that protrudes into it with a predefined retaining force. The hammer operation does not begin until sufficient pressing force is exerted via the tool, which causes the beat piece to force the striker out of the retaining ring, thus allowing it to move freely and respond to the pneumatic impulses of the pressure piston.

A retaining ring of such kind is exposed to relatively high loads when the hammer drill is operated, and accordingly is prone to wear. Accordingly it is desirable to design and develop a hammer drill that includes a retaining ring exposed to less wearing stresses, while at the same time making the device easier and safer to assemble.

### SUMMARY OF THE INVENTION

The example hammer drill includes two discs, a retaining disc and non-return disc, to secure the retaining ring in the tool spindle. In this case, the side of the retaining ring facing the beat piece is braced axially against an annular step in the tool spindle via the non-return disc, while the side of the retaining ring facing the striker is braced axially against a locking ring via the retaining disc, the locking ring being set in an annular groove created in the tool spindle. By selecting appropriate materials for the discs, the mechanical load on the retaining ring may be reduced, which in turn significantly reduces wear on the retaining ring. At the same time, the retaining ring may be created from materials that are more suitable for grasping and retaining the striker.

In one example hammer drill, the retaining ring, the retaining disc and the non-return disc may now each be arranged mirror-symmetrically relative to a centre plane extending perpendicularly to the spindle axis. This configuration precludes the risk of installing the individual elements the wrong way round in the tool spindle. If asymmetrical elements are assembled the wrong way round, the element in question may fail after a very short operating period, and this is therefore undesirable. Installing asymmetrical elements requires extra care on the part of the fitter, which is both labor-intensive and time-consuming. If assembly is automated, additional effort must be expended to prevent any possibility of the elements being installed the wrong way. With the suggested mirror-symmetrical configuration of the individual elements, this additional effort may be avoided. Assembly is correspondingly simpler, and as a result the hammer drill may be manufactured to higher quality specifications and still less expensively.

Another example hammer drill includes a retaining disc and the non-return disc designed as identical parts. With this construction method, it is not possible to mistake the retaining disc for the non-returning disc or vice versa, and this also serves to simplify assembly, which again results in improved quality while lowering manufacturing costs.

Of course, it is possible to implement the two solutions together. The advantages associated with such a combination in terms of simpler assembly and enhanced quality are evident.

A brake ring arranged coaxially with the spindle axis may also be provided, such that a protruding end section of the beat piece advances into this brake ring. This brake ring may now also be configured so as to be mirror-symmetrical about a centre plane extending perpendicularly to the spindle axis. This also serves to simplify assembly.

These and other features of the present invention can be best understood from the following specification and drawings, the following of which is a brief description.

### BRIEF DESCRIPTION OF THE DRAWINGS

FIG. 1 is a longitudinal section through a hammer drill;

FIG. 2 is an enlarged cross section example hammer drill in an area around a retaining ring.

### DETAILED DESCRIPTION OF THE PREFERRED EMBODIMENT

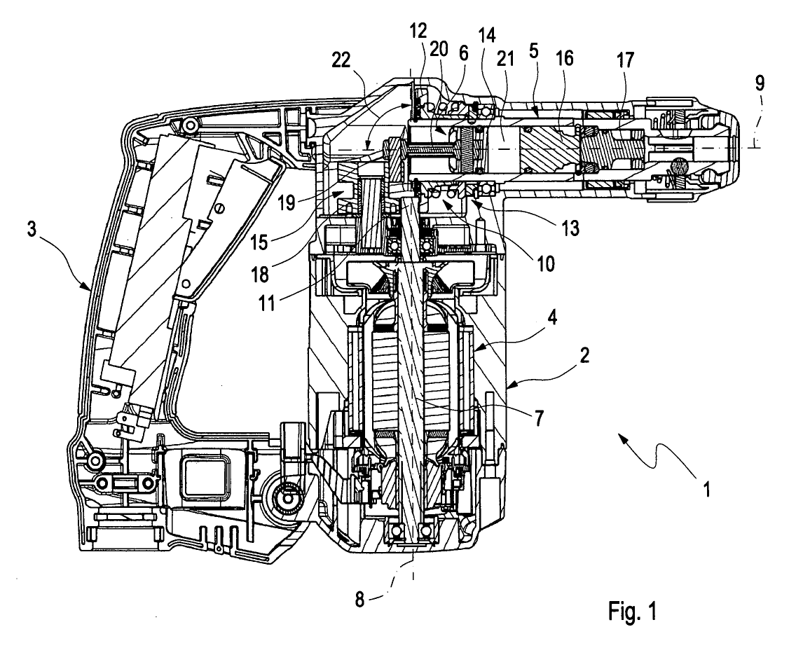

As shown in FIG. 1, a hammer drill 1 intended for manually-guided operation includes a housing 2, which may optionally have a handle 3. Housing 2 of hammer drill 1 holds an electric drive motor 4 as well as a tool spindle 5 and a pneumatic hammer function 6. Drive motor 4 is equipped with a drive shaft 7, which rotates about a shaft axis 8 when hammer drill 1 is operated. Drive motor 4 drives tool spindle 5 in a rotary manner about a spindle axis 9. For this purpose, in the example shown, drive motor 4 is coupled in a driving manner with tool spindle 5 via a spindle gear mechanism 10. For these purposes, spindle gear mechanism 10 is preferably a single-stage gear mechanism, via which tool spindle 5 is driven directly by drive shaft 7. Spindle gear mechanism 10 is preferably configured as an angular gear mechanism and accordingly has a pinion gear 11 attached to or conformed on drive shaft 7, which pinion gear is in engagement with a ring gear 12 that serves to transfer turning moment to tool spindle 5. In this context, it is practical to arrange a safety clutch 13 between ring gear 12 and tool spindle 5, which serves to restrict the turning moment between drive motor 4 and tool spindle 5. In the example shown, pinion gear 11 is furnished with radial toothing that meshes with axial spur gear toothing on ring gear 12, so that ring gear 12 is effectively a crown gear 12.

Hammer function 6 includes a pressure piston 14, which is arranged directly inside tool spindle 5 so as to be linearly displaceable and drivable by a drive motor 4 via a hammer gear mechanism 15. Tool spindle 5 also houses another piston 16 that is arranged so as to be linearly displaceable, and is referred to in the following as striker 16, and which is drivable pneumatically by pressure piston 14. Moreover, a third piston 17 is also arranged so as to be linearly displaceable in tool spindle 5, and this piston is referred to in the following as the beat piece 17. This element is displaceable by striker 16, that is to say it is drivable by direct mechanical contact. Beat piece 17 then serves to beat axially against a tool, not shown in the drawing, which has been secured by a chuck on tool spindle 5 so that hammer drill 1 may be operated, and which is usually a drill bit.

In the preferred embodiment shown here, hammer gear mechanism 15 has a drive wheel 18 that is driven directly by pinion gear 11, and preferably in the same axial section as crown gear 12. In this case, an axis of rotation of drive wheel 18 preferably extends parallel to shaft axis 8. A piston rod 20 is connected to drive wheel 18 eccentrically and in articulated manner via a journal 19, and drives pressure piston 14. This creates a crank mechanism that causes piston rod 20 to displace pressure piston 14 in a reciprocating linear motion between two dead points when drive wheel 18 turns. This creates pressure surges or pressure pulses in a pressure chamber 21 located in tool spindle 5 between pressure piston 14 and striker 16, and these pulses displace striker correspondingly. The striker is forced against beat piece 17 at the same rate as that of the pressure pulses, and this forces beat piece 17 finally against the respective tool as the same frequency as the pressure pulses.

In the embodiment shown in FIG. 1, shaft axis 8 and spindle axis 9 are arranged at an angle 22 relative to one another, and in the example shown, this angle is approximately 90°. In general, angle 22 may be in a range from 60° to 120° inclusive. This feature distinguishes the configuration of hammer drill 1 shown here from other conventional constructions, since shaft axis 8 and spindle axis 9 in those cases are essentially parallel to one another, in a “pistol” configuration.

In a different arrangement from the axial toothing shown here, conical toothing is also entirely conceivable between pinion gear 11 and crown gear 12, particularly when angle 22 is not roughly equal to 90°.

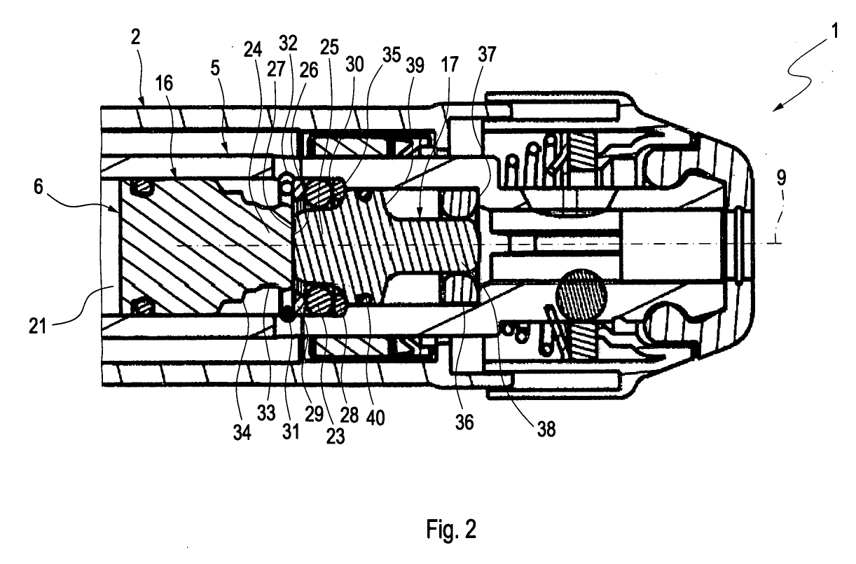

As shown in FIG. 2, hammer function 6 also includes a retaining ring 23 that is positioned coaxially with spindle axis 9. Retaining ring 23 is arranged inside tool spindle 5 and at the same time located axially such that it may be penetrated by a front or protruding end section 24 of striker 16 when striker 16 reaches a forward limit position. FIG. 2 shows a state in which striker 16 has not yet reached its forward limit position. Accordingly, its end section 24 is positioned axially separated from retaining ring 23, and consequently not protruding into it. In the state shown in FIG. 2, beat piece 17 is in its rear limit position, in which the rear section 25 thereof protrudes into retaining ring 23. In the state shown, the protruding front end 26 of striker 16 is touching a rear end 27 of beat piece 17, thereby enabling the pressure pulse to be transmitted.

A non-return disc 28 and a retaining disc 29 ensure that the axial position of retaining ring 25 in tool spindle 5 is fixed. Non-return disc 28 is disposed on a side of retaining ring 23 that faces beat piece 17, while retaining disc 29 is disposed on a side of retaining ring 23 facing striker 16. Retaining ring 23 is braced axially against an annular collar in tool spindle 5 via non-return disc 28. Retaining ring 23 is also braced axially against a locking ring 31 via retaining disc 29. This retaining ring 31 is set into an annular groove 32 conformed radially around the inside of tool spindle 5. Discs 28,29 may be produced from a different material than is used for retaining ring 23. The particular advantage of this is that different materials may be selected depending on their suitability for a given specification. For example, discs 28,29 may be made from a metal, but also from a plastic. They serve to transmit very strong forces between retaining ring 23 and tool spindle 5, and accordingly they are shaped so as to minimise wear on retaining ring 23. Retaining ring 23 may preferably be designed such that when front end section 24 of striker protrudes into it, it cooperates with a retaining contour 33 in striker 16 in the form of a ring-shaped recess extending radially round the striker, and in which retaining ring 23 may engage when striker protrudes deeply into retaining ring 23 upon reaching its forward limit position.

The contouring of protruding end section 24 of striker 16 may include an annular collar 34 that particularly rests flush on retaining disc 29 when striker 16 reaches its forward limit position.

When beat piece 17 is in its rear limit position, as shown, the beat piece is axially flush with an annular step 35 on non-return disc 28. At the same time, the end section 25 thereof may also come into contact with retaining ring 23.

In the hammer drill 1 as shown, retaining ring 23, retaining disc 29 and non-return disc 28 are each arranged mirror-symmetrically relative to a centre plane, not shown here, which extends perpendicularly to spindle axis 9. This ensures that each of these elements cannot be fitted with the wrong orientation. The front and rear are identical, which prevents incorrect assembly. In addition, retaining disc 29 and non-return disc 28 may be designed as identical parts, as is shown in the preferred embodiment here. In this way, it is also possible to avoid confusing the retaining disc 29 and the non-return disc 28. The components are identical and may be used interchangeably with no undesirable effects.

A brake ring 36 is also provided in the embodiment shown here, the brake ring being aligned coaxially with spindle axis 9 and braced against a further annular step 37 in tool spindle 5. A protruding end section 38 of beat piece 17 protrudes into brake ring 36 in the illustrated rear end position as well. The side of beat piece 17 that faces brake ring 36 is furnished with another annular step 39, which in particular lies flush against brake ring 36 when the beat piece reaches its forward limit position. Brake ring 36 may preferably be designed so as to be mirror-symmetrical about a centre plane extending perpendicularly to spindle axis 9, thereby ensuring that it cannot be fitted the wrong way round. Brake ring 36 may be made from metal and may serve to absorb the impact of beat piece 17 when it reaches its forward limit position.

It is advantageous to design beat piece 17 such that its centre of gravity is located roughly in the middle of a longitudinal section of tool spindle 5, and in which at least one seal 40 is also provided. Striker 16 and pressure piston 14 are also furnished with appropriate seals and are guided directly in or along tool spindle 5.

The foregoing description is only exemplary of the principles of the invention. Many modifications and variations are possible in light of the above teachings. It is, therefore, to be understood that within the scope of the appended claims, the invention may be practiced otherwise than using the example embodiments which have been specifically described. For that reason the following claims should be studied to determine the true scope and content of this invention.

What is claimed is:

1. A hammer drill for manually guided operation comprising:
an electric drive motor;
a drivable tool spindle that rotates about a spindle axis;
a pneumatic hammer function that includes a pressure piston disposed in the tool spindle that is displaceable in reciprocating linear fashion, a striker disposed in the tool spindle that is actuated pneumatically by the pressure piston, and a beat piece disposed in the tool spindle that may be propelled by the striker to strike axially against a tool that is held by the tool spindle,
wherein a retaining ring is provided and positioned coaxially with the spindle axis, into which retaining ring an end section of the striker protrudes upon reaching a forward limit position,
wherein a side of the retaining ring facing the beat piece is braced axially against an annular collar of the tool spindle via a non-return disc,
wherein a side of the retaining ring facing the striker is braced axially against a locking ring set into an annular groove on the tool spindle via a retaining disc,
wherein the retaining ring, the retaining disc and the non-return disc are each mirror-symmetrical relative to a center plane extending perpendicularly to the spindle axis.

2. The hammer drill as recited in claim 1, wherein the retaining disc and the non-return disc are identical parts.

3. The hammer drill as recited in claim 1, wherein a brake ring is provided and aligned coaxially with the spindle axis, and into which a front end section of the beat piece protrudes and which is mirror-symmetrical relative to a center plane extending perpendicularly to the spindle axis.

4. The hammer drill as recited in claim 1, wherein the tool spindle is driven directly from a drive shaft of the drive motor via a single-stage spindle gear mechanism.

5. The hammer drill as recited in claim 4, wherein the spindle gear mechanism is designed as an angular gear mechanism having a pinion gear disposed on or conformed from the drive shaft and a ring gear that is engaged with the pinion gear.

6. The hammer drill as recited in claim 5, wherein the pinion gear is furnished with radial toothing and the ring gear is designed as a crown gear and has axial spur gear toothing.

7. The hammer drill as recited in claim 1, wherein the pressure piston is driven directly by a drive shaft of the drive motor via a single-stage hammer gear mechanism.

8. The hammer drill as recited in claim 1, wherein a shaft axis of the drive shaft and a spindle axis of the tool spindle are arranged to one another, wherein the size of this angle can be in a range from 60° to 120° inclusive, and may particularly be approximately 90°.

9. A hammer drill for manually guided operation comprising:
an electric drive motor;
a drivable tool spindle that rotates about a spindle axis;
a pneumatic hammer function that includes a pressure piston disposed in the tool spindle that is displaceable in reciprocating linear fashion, a striker disposed in the tool spindle that is actuated pneumatically by the pressure piston, and a beat piece disposed in the tool spindle that may be propelled by the striker to strike axially against a tool that is held by the tool spindle,
wherein a retaining ring is provided and positioned coaxially with the spindle axis, into which retaining ring an end section of the striker protrudes upon reaching a forward limit position,
wherein a side of the retaining ring facing the beat piece is braced axially against an annular collar of the tool spindle via a non-return disc,
wherein a side of the retaining ring facing the striker is braced axially against a locking ring set into an annular groove on the tool spindle via a retaining disc,
wherein the retaining disc and the non-return disc are identical parts.

10. The hammer drill as recited in claim 9, wherein the retaining ring, the retaining disc and the non-return disc are each mirror-symmetrical relative to a center plane extending perpendicularly to the spindle axis.

11. The hammer drill as recited in claim 9, wherein a brake ring is provided and aligned coaxially with the spindle axis, and into which a front end section of the beat piece protrudes and which is designed mirror-symmetrically relative to a centre plane extending perpendicularly to the spindle axis.

12. The hammer drill as recited in claim 9, wherein the tool spindle is driven directly from a drive shaft of the drive motor via a single-stage spindle gear mechanism.

13. The hammer drill as recited in claim 12, wherein the spindle gear mechanism is designed as an angular gear mechanism having a pinion gear disposed on or conformed from the drive shaft and a ring gear that is engaged with the pinion gear.

14. The hammer drill as recited in claim 13, wherein the pinion gear is furnished with radial toothing and the ring gear is designed as a crown gear and has axial spur gear toothing.

15. The hammer drill as recited in claim 9, wherein the pressure piston is driven directly by a drive shaft of the drive motor via a single-stage hammer gear mechanism.

16. The hammer drill as recited in claim 9, wherein a shaft axis of the drive shaft and a spindle axis of the tool spindle are arranged to one another, wherein the size of this angle can be in a range from 60° to 120° inclusive, and may particularly be approximately 90°.
